(19) United States
(12) Patent Application Publication
(10) Pub. No.: US 2024/0207732 A1
(43) Pub. Date: Jun. 27, 2024

(54) INTERACTION CONTROL METHOD AND DEVICE, COMPUTER APPARATUS AND NON-TRANSITORY COMPUTER-READABLE STORAGE MEDIUM

(71) Applicant: SHANGHAI MULI NETWORK TECHNOLOGY CO., LTD., SHANGHAI (CN)

(72) Inventors: Dingchao QUAN, Beijing (CN); Yun SHI, Beijing (CN); Xi ZHANG, Beijing (CN)

(21) Appl. No.: 18/392,532

(22) Filed: Dec. 21, 2023

(30) Foreign Application Priority Data
Dec. 21, 2022 (CN) 202211648454.0

(51) Int. Cl. A63F 13/42; A63F 13/533; A63F 13/537

(52) U.S. Cl. CPC A63F 13/42; A63F 13/533; A63F 13/537; A63F 13/822

(57) ABSTRACT

The present disclosure provides an interaction control method, device, computer apparatus and a storage medium. The method includes: displaying a virtual scene and at least one first skill button in a display interface of a terminal equipment; the virtual scene comprises a first virtual character; in response to a triggering operation on a target skill button of the at least one first skill button, controlling the first virtual character to release a target skill corresponding to the target skill button and determining a first skill trace corresponding to the target skill; and in response to positions of the first skill trace and a second skill trace in a to-be-triggered state in the virtual scene satisfying a preset position condition, triggering a preset skill effect based on the first skill trace and the second skill trace; wherein the second skill trace is determined at historical time by triggering one of the at least one first skill button.

### CROSS REFERENCE TO RELATED APPLICATION

application claims priority from Chinese Patent Application No. 202211648454.0, filed on Dec. 21, 2022, the contents of which are hereby incorporated by reference in their entirety for all purposes.

### TECHNICAL FIELD

The present disclosure relates to the field of computer technologies, and in particular, to an interaction control method, device, a computer apparatus, and a storage medium.

### BACKGROUND

In current games, a plurality of skill buttons are usually provided, and a user can control a virtual character in the game to release corresponding skills in the game by triggering the skill buttons. In some games, a combined skill can be released by a combination of multiple skills, achieving a different skill effect than those released individually.

The current combined skills are usually triggered by releasing one skill of the combined skills within a period of time after the previous skill of the combined skills is released, and combining the two skills with each other to produce a special skill effect.

### SUMMARY

The embodiment of the disclosure at least provides an interaction control method, device, computer apparatus and a storage medium.

In one aspect, an embodiment of the present disclosure provides an interaction control method comprising:
displaying a virtual scene and at least one first skill button in a display interface of a terminal equipment; the virtual scene comprises a first virtual character;
in response to a triggering operation on a target skill button of the at least one first skill button, controlling the first virtual character to release a target skill corresponding to the target skill button and determining a first skill trace corresponding to the target skill; and
in response to positions of the first skill trace and a second skill trace in a to-be-triggered state in the virtual scene satisfying a preset position condition, triggering a preset skill effect based on the first skill trace and the second skill trace; wherein the second skill trace is determined at historical time by triggering one of the at least one first skill button.

In a possible embodiment, the method further comprises:
after the preset skill effect is triggered based on the first skill trace and the second skill trace, controlling the first skill trace and the second skill trace to disappear.

In a possible embodiment, the method further comprises:
in response to the second skill trace not existing currently or the positions relation of the first skill trace and the second skill trace not satisfying the preset position condition, controlling the first skill trace to enter a to-be-triggered state.

In a possible embodiment, the method further comprises:
after the first skill trace enters the to-be-triggered state, if the first skill trace is not triggered within a preset time period, controlling the first skill trace to disappear.

In a possible embodiment, the triggering a preset skill effect based on the first skill trace and the second skill trace comprises:
determining an effective area of the preset skill effect based on the first skill trace and the second skill trace; and
triggering the preset skill effect in the effective area.

In a possible embodiment, an information indication control is displayed in the display interface; the information indication control is configured to display a residual amount of virtual resource; the virtual resource is used for releasing a skill corresponding to the at least one first skill button;
the after in response to a triggering operation on a target skill button of the at least one first skill button, controlling the first virtual character to release a target skill corresponding to the target skill button, the method further comprises:
determining whether the current residual amount satisfies a release condition of the skill corresponding to the at least one first skill button;
in response to the current residual amount not satisfying the release condition of the skill, controlling the at least one first skill button to enter an untriggerable state; and
in response to the current remaining amount satisfying the release condition of the skill, controlling the at least one first skill button to remain in a triggerable state.

In a possible embodiment, the preset position condition comprises at least one of:
the first skill trace and the second skill trace intersect, are parallel or are tangent, or a distance between the first skill trace and the second skill trace is less than a preset distance threshold value.

In a possible embodiment, the display interface further displays: a second skill button; the method further comprises:
in response to a triggering operation on the second skill button, determining a target area in the virtual scene based on a current position of the first virtual character, and generating at least one third virtual character associated with the first virtual character in the target area;
the in response to a triggering operation on a target skill button of the at least one first skill button, controlling the first virtual character to release a target skill corresponding to the target skill button and determining a first skill trace corresponding to the target skill comprises:
in a case where the first virtual character is located in the target area, in response to the triggering operation on the target skill button of the at least one first skill button, controlling the first virtual character and the third virtual character to release the target skill corresponding to the target skill button, and determining the first skill traces of the target skill released by the first virtual character and the third virtual character respectively.

In a possible embodiment, the method further comprises:
in response to the first skill traces corresponding to the first virtual character and the third virtual character respectively satisfying the preset position condition, triggering the preset skill effect based on the first skill traces corresponding to the first virtual character and the third virtual character respectively.

In a possible embodiment, the method further comprises:
preserving skill traces in the target area; the preserved skill traces comprise: the first skill trace and the second skill trace; and
in response to a disappearance of the target area, triggering the preset skill effect based on the skill traces preserved in the target area.

In a possible embodiment, the method further comprises: in response to the first virtual character moving within the target area, controlling the third virtual character to move within the target area based on a manner in which the first virtual character moves within the target area.

In a possible embodiment, the method further comprises:
in response to a duration of existence of the target area reaching a preset duration, controlling the target area to disappear; and/or
in response to the first virtual character moving from within the target area to outside the target area, controlling the target area to disappear.

In a possible embodiment, the in response to a triggering operation on a target skill button of the at least one first skill button, controlling the first virtual character to release a target skill corresponding to the target skill button comprises:
in response to a triggering operation on the target skill button of the at least one first skill button and when the first virtual character is located within the target area, controlling the first virtual character to release the target skill corresponding to the target skill button without consuming virtual resource; and
when the first virtual character is located outside the target area, controlling the first virtual character to release the target skill corresponding to the target skill button by consuming the virtual resource.

In another aspect, an embodiment of the present disclosure provides an interactive control device, comprising:
a display module configured to display a virtual scene and at least one first skill button in a display interface of a terminal equipment; the virtual scene comprises a first virtual character;
a first trigger module configured to, in response to a triggering operation on a target skill button of the at least one first skill button, control the first virtual character to release a target skill corresponding to the target skill button and determine a first skill trace corresponding to the target skill;
a second trigger module configured to, in response to positions of the first skill trace and a second skill trace in a to-be-triggered state in the virtual scene satisfying a preset position condition, trigger a preset skill effect based on the first skill trace and the second skill trace; wherein the second skill trace is determined at historical time by triggering one of the at least one first skill button.

In a possible embodiment, the second trigger module is further configured to:
after the preset skill effect is triggered based on the first skill trace and the second skill trace, control the first skill trace and the second skill trace to disappear.

In a possible embodiment, the first trigger module is further configured to:
in response to the second skill trace not existing currently or the positions of the first skill trace and the second skill trace not satisfying the preset position condition, control the first skill trace to enter a to-be-triggered state.

In a possible embodiment, the first trigger module is further configured to:
after the first skill trace enters the to-be-triggered state, if the first skill trace is not triggered within a preset time period, control the first skill trace to disappear.

In a possible embodiment, the second trigger module when triggers a preset skill effect based on the first skill trace and the second skill trace, is further configured to:
determine an effective area of the preset skill effect based on the first skill trace and the second skill trace; and
trigger the preset skill effect in the effective area.

In a possible embodiment, the display module displays an information indication control in the display interface; the information indication control is configured to display a residual amount of virtual resource; the virtual resource is used for releasing a skill corresponding to the at least one first skill button;
the second trigger module, after in response to a triggering operation on a target skill button of the at least one first skill button, control the first virtual character to release a target skill corresponding to the target skill button, is further configured to:
determine whether the current residual amount satisfies a release condition of the skill corresponding to the at least one first skill button;
in response to the current residual amount not satisfying the release condition of the skill, control the at least one first skill button to enter an untriggerable state; and
in response to the current remaining amount satisfying the release condition of the skill, control the at least one first skill button to remain in a triggerable state.

In a possible embodiment, the display module further displays a second skill button in the display interface; the device further comprises a third trigger module configured to:
in response to a triggering operation on the second skill button, determine a target area in the virtual scene based on a current position of the first virtual character, and generate at least one third virtual character associated with the first virtual character in the target area;
the third trigger module, when in response to a triggering operation on a target skill button of the at least one first skill button, controls the first virtual character to release a target skill corresponding to the target skill button and determine a first skill trace corresponding to the target skill comprises, is further configured to:
in a case where the first virtual character is located in the target area, in response to the triggering operation on the target skill button of the at least one first skill button, control the first virtual character and the third virtual character to release the target skill corresponding to the target skill button, and determine the first skill traces of the target skill released by the first virtual character and the third virtual character respectively.

In a possible embodiment, the third trigger module is further configured to:
in response to the first skill traces corresponding to the first virtual character and the third virtual character respectively satisfying the preset position condition, trigger the preset skill effect based on the first skill traces corresponding to the first virtual character and the third virtual character respectively.

In a possible embodiment, the third trigger module is further configured to:
preserve skill traces in the target area; the preserved skill traces comprise: the first skill trace and the second skill trace; and
in response to a disappearance of the target area, trigger the preset skill effect based on the skill traces preserved in the target area.

In a possible embodiment, the third trigger module is further configured to:
in response to the first virtual character moving within the target area, control the third virtual character to move within the target area based on a manner in which the first virtual character moves within the target area.

In a possible embodiment, the second trigger module, when in response to a triggering operation on a target skill button of the at least one first skill button, controls the first virtual character to release a target skill corresponding to the target skill button, is further configured to:
in response to a triggering operation on the target skill button of the at least one first skill button and when the first virtual character is located within the target area, control the first virtual character to release the target skill corresponding to the target skill button without consuming virtual resource; and
when the first virtual character is located outside the target area, control the first virtual character to release the target skill corresponding to the target skill button by consuming the virtual resource.

In still another aspect, an embodiment of the present disclosure provides computer apparatus, comprising: a processor, a memory storing machine-readable instructions executable by the processor, the processor is configured to execute the machine-readable instructions stored in the memory, the machine-readable instructions, when executed by the processor, cause the processor to perform the steps of the above aspect or any possible embodiments of the above aspect.

In still another aspect, an embodiment of the present disclosure provides a computer-readable storage medium, a computer program is stored on the computer-readable storage medium, the computer program, when executed by a computer apparatus, cause the computer apparatus to perform the steps of the above aspect or any possible embodiments of the above aspect.

In order to make the aforementioned objects, features and advantages of the present disclosure more comprehensible, preferred embodiments accompanied with figures are described in detail below.

### BRIEF DESCRIPTION OF THE DRAWINGS

In order to more clearly illustrate the technical solutions of the embodiments of the present disclosure, the drawings required in the embodiments will be briefly described below, and the drawings herein incorporated in and forming a part of the specification illustrate embodiments consistent with the present disclosure and, together with the description, serve to explain the technical solutions of the present disclosure. It is to be understood that the following drawings depict only certain embodiments of the disclosure and are therefore not to be considered limiting of its scope, for those skilled in the art to which the disclosure pertains without the benefit of the inventive faculty, and that additional related drawings can be derived therefrom.

FIG. 1 illustrates a flow chart of an interaction control method provided by some embodiments of the present disclosure;

FIG. 2 illustrates an example diagram of the effective area for the preset skill effect provided by some embodiments of the present disclosure;

FIG. 3 illustrates an example diagram of an information indication control provided by some embodiments of the present disclosure;

FIG. 4 illustrates an example diagram of releasing a target skill within a target area provided by some embodiments of the present disclosure;

FIG. 5a illustrates an example diagram of a battle scenario provided by some embodiments of the present disclosure;

FIG. 5b illustrates an example diagram of another battle scenario provided by some embodiments of the present disclosure;

FIG. 5c illustrates an example diagram of yet another battle scenario provided by some embodiments of the present disclosure;

FIG. 5d illustrates an example diagram of yet another battle scenario provided by some embodiments of the present disclosure;

FIG. 6 illustrates a schematic diagram illustrating an interactive control device provided by an embodiment of the present disclosure;

FIG. 7 illustrates a schematic diagram of a computer apparatus provided by an embodiment of the present disclosure.

### DETAILED DESCRIPTION

To make the objects, technical solutions and advantages of the embodiments of the present disclosure more apparent, the technical solutions in the embodiments of the present disclosure will be described clearly and completely with reference to the drawings in the embodiments of the present disclosure, and it is obvious that the described embodiments are only a part of the embodiments of the present disclosure, not all of the embodiments. The components of embodiments of the present disclosure, as generally described and illustrated herein, can be arranged and designed in a wide variety of different configurations. Thus, the following detailed description of the embodiments of the disclosure is not intended to limit the scope of the disclosure as claimed, but is merely representative of selected embodiments of the disclosure. All other embodiments, which can be derived by a person skilled in the art from the embodiments of the disclosure without making any creative effort, shall fall within the protection scope of the disclosure.

It has been found that in the skill mechanism of some game characters, special skill effects can be generated through the combined release of a plurality of skills.

Taking a Multiplayer Online Battle Arena (MOBA) game as an example, a user controls hero (virtual character) in a map including “three soldier lanes”, “four wild areas”, “two bases”, “several defense towers”, “creeps”. The 5V5 battle is carried out by playing the responsible role of “topsolo”, “midsolo”, “roaming” “jungle”, and the like, and each hero has respective skills and aims at destroying enemy base. In order to pursue the visual experience of games, a certain skill special effect is displayed when designing hero skills. For example, when the hero waves the weapon in hand, a waving light effect will be generated, when the hero hits the ground with the weapon, it will leave skill trace on the ground, or some skills of the hero may change the terrain of the virtual scene, or generate a skill area in the virtual scene and so on. In order to increase the operability of the game, a developer usually designs combined skills releasing a plurality of skills to cooperate with each other when designing the hero skills. When releasing the combined skill, whether the release of the combined skill is successful or not is determined by limiting the release sequence and the release time of the skills. For example, a combined skill consists of two skills, the first skill must be released first, and after the first skill is released, special skill effects can be triggered by releasing the second skill. The special skill effects such as effective range, injury caused by skill and the like are usually fixed, and the room for control by the user is small. This method of skill release lacks the flexibility to control skill release.

Based on the research, the interactive control method provided by the disclosure triggers the preset skill effects by controlling the release position of the skill, and then adjusting the position of the skill trace left after the skill is released, so that the skill trace left by the skill satisfies the preset position condition. Thus, the trace released by the skill can be flexibly determined according to the progress of the game or prediction, so as to control the effective range of the skill, the damage intensity of the skill and other skill effects, and increase the flexibility of control during the skill release process.

The above drawbacks are the results of the practical and careful study of the inventors, and therefore, the discovery process of the above problems and the solutions proposed by the present disclosure in the following description should be the contribution of the inventor to the present disclosure in the course of the present disclosure.

It should be noted that like reference numbers and letters refer to like items in the following figures, and thus, once an item is defined in one figure, it need not be further defined or explained in subsequent figures.

In addition, before using the technical solutions disclosed in the following embodiments of the present disclosure, the user should be informed of the type, the usage scope, the usage scenario, and so forth of the personal information related to the present disclosure in a proper manner according to the relevant laws and regulations and obtain the authorization of the user.

For example, in response to receiving an active request from the user, prompt information is sent to the user to explicitly prompt the user that the requested operation to be performed would require acquisition and use of personal information to the user. Thus, the user can autonomously select whether to provide personal information to software or hardware such as an electronic device, an application program, a server, or a storage medium that performs the operations of the technical solution of the present disclosure, according to the prompt information.

As an alternative but non-limiting implementation manner, in response to receiving an active request from the user, the manner of sending the prompt information to the user can be, for example, in the form of a pop-up window, and the prompt information can be presented in the form of text in the pop-up window. In addition, a selection control for providing personal information to the electronic apparatus by the user's selection of “agree” or “disagree” can be carried in the pop-up window.

It is understood that the above notification and user authorization process is only illustrative and is not intended to limit the embodiment of the present disclosure, and other ways of satisfying the relevant laws and regulations can be applied to the embodiment of the present disclosure.

To facilitate understanding of this embodiment, first, an interaction control method disclosed in an embodiment of the present disclosure is described in detail, where an executive subject of the interaction control method provided by the embodiment of the present disclosure is generally a computer apparatus with certain computing capability, and the computer apparatus includes, for example a terminal device including, for example, a touch terminal and a Personal Computer (PC) terminal, or a server or other processing device. The touch terminal includes, for example, smart phones, tablet computers, and the like; the PC terminal includes, for example, a desktop computer, a notebook computer, and the like.

The terminal device is provided with an application program corresponding to the target game, and when the application program runs in the terminal device, a user can obtain an image in the target game by using the interactive control method provided by the embodiment of the disclosure. It should be noted that the application can be executed on the server, the server performs related data processing, and the terminal device can display data transmitted by the server as the display device. When an application program runs in the terminal equipment, a virtual scene is displayed in an interface of the terminal equipment, and the virtual scene contains virtual characters.

The interaction control method provided by the embodiment of the disclosure can be applied to any virtual scene for performing interaction control on the virtual character, such as a game, a virtual community established depending on the virtual scene, and the like. The interaction control method provided by the embodiment of the disclosure is suitable for any MOBA-type game, or Role-Playing Game (RPG) that controls the virtual character to release the target skill, and the like, and the virtual community, and the like.

Taking the application of the interactive control method provided by the embodiment of the disclosure to a game as an example, when the game runs in the terminal device, a virtual scene of the game can be displayed in an interface of the terminal device. A virtual character is included in the virtual scene. The virtual character may include, but are not limited to, virtual characters controlled by a user, and non-player characters (NPC). The virtual character may include, but is not limited to, at least one of a virtual human, or a virtual animal. The virtual character capable of being controlled by a user, and a non-player character can be set according to game requirements, and is not particularly limited herein.

An interactive control method provided by the embodiments of the present disclosure is described below.

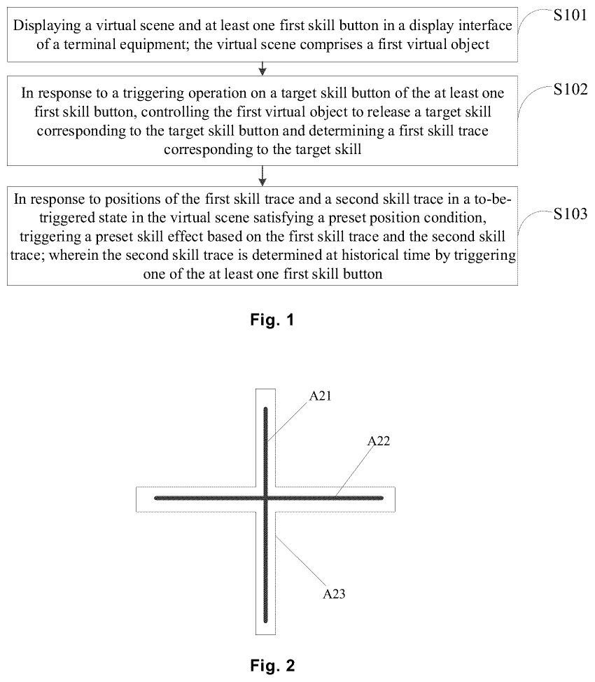

Referring to FIG. 1, a flowchart of an interaction control method provided by the embodiment of the present disclosure is shown, where the method includes steps S101 to S103, where:

S101: displaying a virtual scene and at least one first skill button in a display interface of a terminal equipment; the virtual scene comprises a first virtual character.

Here, the display interface indicates a display interface in a target game equipped with an interactive control method provided by the present disclosure, the display interface may include at least one first skill button, and each first skill button is bound with a corresponding target skill. Under some special skill mechanisms, one target skill may have multiple skill release stages, and each skill release stage of the target skill is sequentially released based on a trigger sequence of the at least one first skill button.

In addition, based on the setting of the target game, controls for controlling the first virtual character to move, jump, climb, crouch and the like can be displayed in the display interface, and the first virtual character can realize various actions allowed by the target game in the virtual scene by triggering the controls.

The first virtual character is a virtual character controlled by a user, and in the MOBA type game, the first virtual character is hero controlled by the game user in the this game. The user controls hero to fight in the virtual scene to destroy the enemy base as the condition for victory.

S102: in response to a triggering operation on a target skill button of the at least one first skill button, controlling the first virtual character to release a target skill corresponding to the target skill button and determining a first skill trace corresponding to the target skill.

Here, the target skill button represents one of the plurality of first skill buttons, and the first skill button is determined as the target skill button based on a trigger operation of the user on any one of the plurality of first skill buttons. After the user triggers the target skill button, the first virtual character is controlled to release the target skill corresponding to the target skill button in the virtual scene, leaving a first skill trace corresponding to the target skill in the virtual scene.

For example, based on the triggering operation of the user on a target skill button in the plurality of first skill buttons, a target skill corresponding to the target skill button is released in the virtual scene. For example, if the target skill corresponding to the target skill button is to control a first virtual character to smash the ground using a weapon, a corresponding trace of the first skill after the hit can be left on the ground of the virtual scene. For example, if the target skill corresponding to the target skill button is to control the first virtual character to move for a distance quickly, traces of the first skill after movement can be left on the ground of the virtual scene.

Here, the first skill traces are only used as an example for illustration, and specifically based on the setting of the target game, other forms of target skills may also be designed, and corresponding first skill traces are left in the virtual scene, which is not limited in any way by the present disclosure.

Following the step S102, in the interaction control method provided by the embodiment of the present disclosure, after releasing the target skill and leaving a first skill trace in the virtual scene, the method further includes:

s103: in response to positions of the first skill trace and a second skill trace in a to-be-triggered state in the virtual scene satisfying a preset position condition, triggering a preset skill effect based on the first skill trace and the second skill trace; wherein the second skill trace is determined at historical time by triggering one of the at least one first skill button.

Here, the second skill trace in the to-be-triggered state is a skill trace left in the virtual scene by a previous target skill of the current target skill, and the previous target skill and the current target skill may be the same target skill or different target skills.

For example, in response to the second skill trace in the to-be-triggered state already existing in the current virtual scene, when the target skill button is triggered by the user to release the target skill, the positions of the first skill trace and the second skill trace of the target skill in the virtual scene satisfy the preset position condition, and at this time, the preset skill effect is triggered based on the positions of the first skill trace and the second skill trace in the virtual scene.

The preset skill effect here may be a skill effect causing injury or control, such as explosion, burning, freezing, or the like, or a skill effect such as a halo producing treatment or gain, and is specifically determined based on the skill setting of the first virtual character.

In some embodiments provided by the present disclosure, after triggering the preset skill effect based on the first skill trace and the second skill trace, the first skill trace and the second skill trace are controlled to disappear.

For example, after a first skill trace and a second skill trace trigger a preset skill effect, the first skill trace and the second skill trace are controlled to disappear in the virtual scene, that is, the skill trace triggering the preset skill effect will not be triggered again.

In addition, the skill traces triggering the preset skill effect can also be triggered repeatedly, the repeated triggering times can be preset, the skill traces after reaching the times disappear in the virtual scene, and specifically, the repeated triggering times can be determined based on the skill setting of the target game.

In some embodiments provided by the present disclosure, an effective area of the preset skill effect is determined based on the first skill trace and the second skill trace; and the preset skill effect is triggered in the effective area.

For example, when the first skill trace and the second skill trace satisfy the preset position condition and the preset skill effect is triggered in the virtual scene, the effective area of the preset skill effect can be determined based on the first skill trace and the second skill trace. Referring to the example diagram of the effective area of the preset skill effect shown in FIG. 2, the first skill trace a21 and the second skill trace a22 satisfy a preset position condition in the virtual scene, and the effective area a23 of the preset skill effect is determined based on the range of the skill traces of the first skill trace a21 and the second skill trace a22. The extent of the effective area a23 is determined based on the shape and extent of the first and second skill traces, and other virtual characters within the effective area a23 can be affected by the preset skill effect.

Here, the shapes of the first skill trace a21 and the second skill trace a22 in FIG. 2 are only used as an example for illustration, and specifically, other shapes such as a circle, an arc, a circular ring, a square and the like can also be used, and the present disclosure does not set any limit on the specific shapes of the skill traces.

Also, the range of the effective area a23 in FIG. 2 is only used as an example for illustration, the specific effective range can be determined based on the skill setting of the target game, and the disclosure does not set any limit to the range of the effective area.

In other embodiments provided by the present disclosure, the preset position condition includes at least one of: the first skill trace and the second skill trace intersect, are parallel and are tangent, and the distance between the first skill trace and the second skill trace is less than a preset distance threshold value.

Here, the preset position condition can be set by arbitrarily selecting one or more combinations of the above based on the skill setting of the target game. If the target game intends to improve the operability of the game, any one of intersection, parallel, and tangency of the first skill trace and the second skill trace can be selected. If the target game intends to reduce the difficulty of the game, all of the above possible situations can be used as the conditions for satisfying the preset position condition.

In other embodiments provided by the present disclosure, in response to the second skill trace not existing currently or the position condition between the first skill trace and the second skill trace not satisfying the preset position condition, the first skill trace is controlled to enter a to-be-triggered state.

For example, when a second skill trace in a to-be-triggered state does not exist in a current virtual scene, a user releases a target skill by triggering a target skill button to leave a first skill trace in the virtual scene. At this time, because the second skill trace does not exist in the virtual scene, the first skill trace is controlled to enter the to-be-triggered state, and the preset skill effect is triggered when the first skill trace currently entered the to-be-triggered state and a subsequent first skill trace left in the virtual scene after the target skill is released later satisfy a preset position condition. That is, the first skill trace currently entered the to-be-triggered state is the second skill trace in the to-be-triggered state relative to the first skill trace left by releasing the target skill later.

In another example, when a second skill trace to be triggered exists in the current virtual scene, but the first skill trace left by releasing the target skill later does not satisfy a preset position condition with the second skill trace, the first skill trace is controlled to enter a to-be-triggered state. At this time, for a first skill trace left by releasing the target skill later in a first virtual scene, two second skill traces in the to-be-triggered state exist in the virtual scene, and so forth. If a first skill trace left by releasing the target skill later does not satisfy the preset position condition with the second skill trace in the to-be-triggered state before, the first skill trace continues to be controlled to enter the to-be-triggered state. That is, if the first skill trace left by releasing the target skill currently in the virtual scene does not satisfy the preset position condition with the second skill trace in the to-be-triggered state before in the virtual scene, the current first skill trace enters a to-be-triggered state and waits for the first skill trace to be triggered.

In other embodiments provided by the present disclosure, after the first skill trace enters the to-be-triggered state, if the first skill trace is not triggered within a preset time period, the first skill trace is controlled to disappear.

For example, after a first skill trace enters a to-be-triggered state (that is, being a second skill trace in the to-be-triggered state for a subsequent first skill trace), a preset time period may exist in a virtual scene, and if the first skill trace does not satisfy a preset position condition with the subsequent first skill trace within the preset time period, the first skill trace entered the to-be-triggered state is controlled to disappear in the virtual scene. That is, after the preset time period, the first skill trace in the to-be-triggered state cannot be triggered by the subsequent first skill trace, the preset time period represents the effective trigger time of the first skill trace entered the to-be-triggered state. Within the effective trigger time, the first skill trace can be triggered by the other subsequent first skill traces, and outside the effective trigger time, the first skill trace cannot be triggered by the other subsequent first skill traces.

In some embodiments provided by the present disclosure, an information indication control is displayed in the display interface; the information indication control is configured to display the residual amount of the virtual resources; the virtual resource is used for releasing a skill corresponding to the at least one first skill button; after in response to a triggering operation on a target skill button of the at least one first skill button, controlling the first virtual character to release a target skill corresponding to the target skill button, it is determined whether the current residual amount satisfies a release condition of the skill corresponding to the at least one first skill button; in response to the current residual amount not satisfying the release condition of the skill, the at least one first skill button is controlled to enter an untriggerable state; and in response to the current remaining amount satisfying the release condition of the skill, the at least one first skill button is controlled to remain in a triggerable state.

Here, the specific expression form of the virtual resource can be an energy value, an energy point, an energy crystal, and the like, the information indication control is a container in which the virtual resource is stored, and the virtual resource corresponding to the target skill is consumed each time the target skill is released.

In response to a triggering operation on a target skill button of the at least one first skill button, controlling the first virtual character to release a target skill corresponding to the target skill button represents that the triggering operation of the target skill button of the at least one first skill button at this time satisfies the releasing condition of the skill.

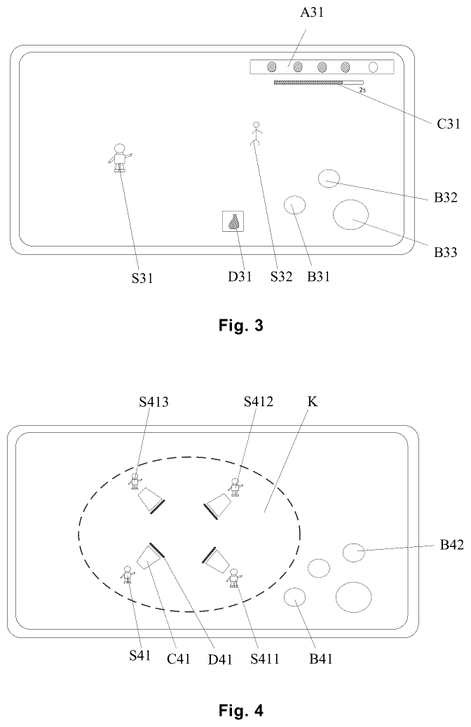

For example, referring to the example diagram of the information indication controls shown in FIG. 3, the information indication controls are represented by an energy container a31. The energy container a31 includes five energy slots, one energy point for each energy slot. Two energy points are consumed to release the first skill corresponding to the first skill button B31, and three energy points are consumed to release the second skill corresponding to the second skill control button B32. That is, in this case, the possible skill combination is to release the first skill corresponding to the first skill button B31 twice, or to release the first skill corresponding to first skill button B31 once and the second skill corresponding to second skill button B32 once. If the second skill corresponding to the second skill button B32 has been released once, the second skill button B32 enters a untriggerable state, and the first skill button still keeps a triggerable state. If the first skill corresponding to the first skill button B31 has been released twice in succession, both the first skill button B31 and the second skill button B32 enter the untriggerable state.

In addition, the virtual resource can be supplemented under a preset condition. For example, when an empty energy slot exists in the energy container A31, the following supplementing method of a31-a33 can be adopted to recover the energy point, wherein:

a31: hitting the enemy virtual character with a normal attack of the first virtual character.

In FIG. 3, a normal attack release button B33 is also shown, and the user controls the first virtual character S31 to release a normal attack by clicking the normal attack release button B33, and when the normal attack of the first virtual character S31 hits the enemy virtual character S32 and in the case where there is an empty energy slot in the energy container a31, one energy point is supplemented. In this case, the possible skill combination can be changed to after releasing the first skill corresponding to the first skill button B31, when adding one energy point by clicking the normal attack release button B33 to make a normal attack released by the first virtual character S31 to hit the enemy virtual character S32, the first skill corresponding to the first skill button B31 can be released again twice in succession. That is, the order of combos is: the first skill+normal attack+the first skill+the first skill. The first skill here can be an injury skill, and thus, one more injury of the first skill can be made in a short time by adding one normal attack, and the upper injury limit of the first virtual character is increased.

Otherwise, after releasing the second skill corresponding to the second skill button B32, when one energy point is added by clicking the normal attack release button B33 to make the normal attack released by the first virtual character S31 to hit the enemy virtual character S32, the second skill corresponding to the second skill button B32 are released again. That is, the order of combos is: the second skill+normal attack+the second skill. The second skill here can be a displacement skill. Thus, by adding one normal attack, displacement can be performed more than once in a short time, increasing flexibility of the first virtual character.

In addition, after one energy point is added by clicking the normal attack release button B33 to make the normal attack released by the first virtual character S31 to hit the enemy virtual character S32, the supplementary method will enter the cooldown. If the enemy virtual character S32 is hit by the normal attack again within a certain period of time, no energy point will be added, so that the number of times of releasing the target skill by the first virtual character S31 is limited during a certain period of time, and the purpose of game balance is achieved.

In addition, besides increasing the energy points by hitting the enemy virtual character with the normal attack, some or all skills can be set to hit the enemy virtual character to increase the energy points, so that the flexibility of energy point acquisition is improved.

a32: supplementing the virtual resources with a preset number every time a preset period of time passes.

In the case where an empty energy slot exists in the energy container a31, a timing control C31 is displayed in the display interface, and one energy point is added to the energy container a31 every time a preset time period (for example, 2S) elapses, so as to limit the number of times that the target skill is released by the first virtual character S31 during a certain period of time, and the purpose of game balance is achieved.

a33: supplementing the virtual resources with a preset number by using the virtual props.

In the case where an empty energy slot exists in the energy container a31, the user can trigger virtual props placement control D31 to trigger the use of virtual props to supplement energy points. The virtual props can be represented in forms of medicines, crystals and the like, and different numbers of energy points can be supplemented based on the difficulty level of obtaining the virtual props or the value of the virtual props in the game. After the virtual props is used once, the virtual props placement control enters cooldown, and the virtual props placement control D31 cannot be triggered again to use the virtual props during the cooldown time, so as to limit the number of times that the target skill of the first virtual character S31 is released during a certain period of time, and the purpose of game balance is achieved.

In addition, one or more of the supplement methods of a31-a33 can be adopted based on specific settings of a target game, and when a plurality of supplement methods are adopted, the cooldown time can be calculated independently or can be shared. For example, when one of the supplement method is used, the other supplement methods also enter cooldown.

The supplementary method a31 to a33 in the present disclosure are only examples, and specifically, other supplementary methods can be provided, and the representation modes of the information indication control, the virtual resource, and the like can be adjusted based on the specific setting of the target game, and the present disclosure is not limited in any way.

In other embodiments provided by the present disclosure, the display interface further displays a second skill button; in response to a triggering operation on the second skill button, a target area in the virtual scene is determined based on a current position of the first virtual character, and at least one third virtual character associated with the first virtual character is generated in the target area.

Here, the specific form of the third virtual character can be represented as a pet, a puppet, a clone, or the like of the first virtual character. Taking the clone as an example, after the user triggers the second skill button, a target area is generated in the virtual scene, three clones are summoned in the target area to assist the first virtual character in fighting, and the clone can imitate the skills and the actions of the first virtual character.

Then, when the first virtual character is controlled to release the target skill corresponding to the target skill button and a first skill trace corresponding to the target skill is determined in response to the triggering operation on the target skill button of the at least one first skill button, in a case where the first virtual character is located in the target area, in response to the triggering operation on the target skill button of the at least one first skill button, the first virtual character and the third virtual character are controlled to release the target skill corresponding to the target skill button and the first skill traces of the target skill released by the first virtual character and the third virtual character respectively is determined.

For example, referring to the example diagram of releasing the target skills within the target area shown in FIG. 4, the user triggers the target skill button B42 to generate the target area K in the virtual scene, and the user triggers the target skill button B41 to control the first virtual character S41 to release the first skill C41 in the target area K. At the same time, the clone S411 (third virtual character), the clone S412 and the clone S413 located within the target area K imitate the first virtual character S41 to release the same first skill C41. At this time, four first skill traces D41 are left in the target area K of the virtual scene, and four first skill traces D41 are symmetrically distributed based on the central point of the target area K.

In other embodiments provided by the present disclosure, in response to the first skill traces corresponding to the first virtual character and the third virtual character respectively satisfying the preset position condition, the preset skill effect is triggered based on the first skill traces corresponding to the first virtual character and the third virtual character respectively.

For example, in the target area, when the first skill traces left by the first virtual character and the third virtual character in the target area of the virtual scene respectively satisfy the preset position condition, the first skill traces satisfying the preset position condition can trigger the preset skill effect. That is, within the target area, the preset skill effect can be triggered by releasing the target skill only once.

In other embodiments provided by the present disclosure, skill traces in the target area is preserved; the preserved skill traces comprise: the first skill trace and the second skill trace; and in response to the disappearance of the target area, the preset skill effect is triggered based on the skill traces preserved in the target area.

For example, in the target area, the skill trace left by the user releasing the target skill by triggering the target skill button does not disappear before the target area disappears, wherein the skill trace includes a first skill trace and a second skill trace which have triggered the preset skill effect. When the target area disappears, the skill traces in the target area trigger the preset skill effect again, and then the skill trace disappears.

In yet another example, the first and second skill traces which have triggered the preset skill effect in the target area may not disappear, but may not trigger the preset skill effect again by other skill traces. That is, the skill trace that has triggered the preset skill effect in the target area may not be triggered again by other skill traces, and the preset skill effect can be triggered again only when the target area disappears.

In addition, the skill traces that have triggered the preset skill effect in the target area can also trigger the preset skill effect again by other skill traces, which are specifically determined based on the skill setting of the game, and are not described in detail in this disclosure.

In some embodiments provided by the disclosure, in response to a triggering operation on the target skill button of the at least one first skill button and when the first virtual character is located within the target area, the first virtual character is controlled to release the target skill corresponding to the target skill button without consuming virtual resource; and when the first virtual character is located outside the target area, the first virtual character is controlled to release the target skill corresponding to the target skill button by consuming the virtual resource.

For example, for the case where the first virtual character is located in the target area when the target skill button is triggered, the remaining amount of the virtual resource in the information indication control can be locked. That is, the first virtual character does not consume the virtual resource in the information indication control when releasing the target skill in the target area, and the first virtual character can continuously release the target skill in the target area.

In another example, for the case where the first virtual character is located outside the target area when the target skill button is triggered, the virtual resources in the information indication control is consumed. When the remaining amount of the virtual resources in the information indication control is insufficient to support the next release of the target skill, the target skill button corresponding to the target skill is controlled to enter the untriggerable state.

In some other embodiments provided by the present disclosure, in response to the first virtual character moving within the target area, the third virtual character is controlled to move within the target area based on a manner in which the first virtual character moves within the target area.

For example, within the target area, when the user triggers the movement control in the display to control the movement of the first virtual character, the third virtual character within the target area is controlled to move symmetrically with respect to the center point of the target area. For example, when the first virtual character moves to the center of the target area, the third virtual character also moves to the center of the target area, and when the first virtual character moves to the outer side of the target area, the third virtual character also moves to the outer side of the target area.

In other embodiments provided by the present disclosure, in response to a duration of existence of the target area reaching a preset duration, controlling the target area to disappear; and/or, in response to the first virtual character moving from within the target area to outside the target area, controlling the target area to disappear.

For example, when the user triggers the second skill button on the display interface and a target area is generated in the virtual scene, the timer starts to count based on a preset duration that the target area exists in the virtual scene, and when timer has not reached the preset duration, the target area does not disappear no matter whether the first virtual character is located in the target area. Specifically, for example, when the first virtual character is located outside the target area, a third virtual character in the target area does not imitate the action of the first virtual character any more, and when the first virtual character is located in the target area, the third virtual character continues to imitate the action of the first virtual character. When the timer reaches the preset duration, the target area disappears, and the third virtual character disappears as well.

In another example, after the target area is generated in the virtual scene, when the user actively or passively moves out of the target area, the target area may disappear, and the third virtual character in the target area may disappear as well. The term actively represents that the user controls the first virtual character to move out of the target area via a moving button on the display interface; the term passively represents that the first virtual character is forced to be displaced outside the target area by some skill of the enemy virtual character and the like.

In addition, the above two conditions for disappearing the target area may also be applied in combination. For example, when the timer is less than the preset time period, if the first virtual character moves out of the target area, the target area disappears, and when the timer satisfies the preset time period, even if the first virtual character is still located in the target area, the target area disappears. Based on the setting of the target game, the target area can be defined in various ways, for example, the preset duration of the target area is extended by props or skill levels, the target area moves along with the first virtual character, the first virtual character in the target area is not affected by the control effect, and the like, which is not described in detail in this disclosure.

In addition, the present disclosure also provides a specific example of interactive control, taking the MOBA game as an example of the target game, in a plurality of virtual characters (hero) in the target game, there is a first virtual character (target hero), and the user selects the target hero to participate in the battle in one game. The target hero may have four skills, including one passive skill and three active skills, and the effect of the passive skill is: when the target hero releases the first skill and the second skill, a knife mark (skill trace) is left in the virtual scene, and the knife mark stays in the virtual scene for three seconds, and the knife mark explodes when contact with each other. The effect of first skill out of three active skills is: consuming two energy points, waving the knife forwards by the target hero to cause damage to the target (enemy hero, enemy soldier and creeps) in the range, and leaving a knife mark at the end of the range. The effect of the second skill is: consuming three energy points, the target hero sprints in the selected direction once, causing damage to the target on the sprint path, and leaving a knife mark on the punching path. When the first skill is used during the displacement process, a transverse cut is made in the displacement direction to cause damage and leave the knife mark. The skill effect of the third skill is to generate a field (target area) in a virtual scene, three independent colons are summoned in the field to assist in the battle, and the clones will copy the skills of the target hero. The field exists for three seconds, during which the target hero can use the first skill and the second skill without consuming the energy points. The knife marks left by releasing skills by the target hero and the clones can explode and cause damage when contacted with each other. The knife marks in the field do not disappear, and when the field is finished, the knife marks can explode again to cause damage. The target in the field can be reduced in moving speed and attracted to the center of the field.

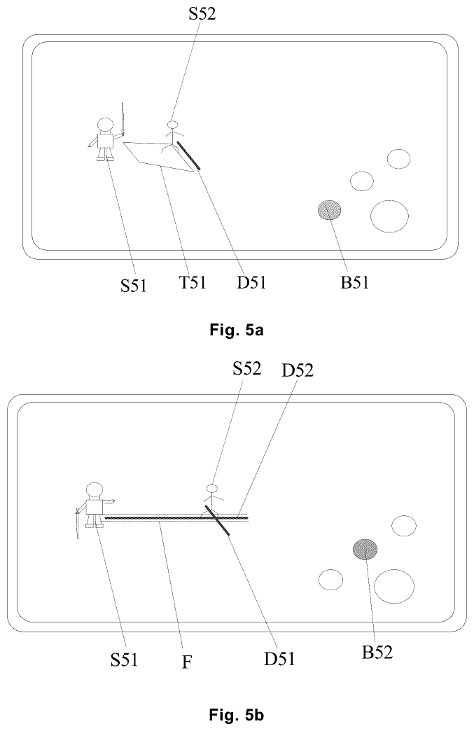

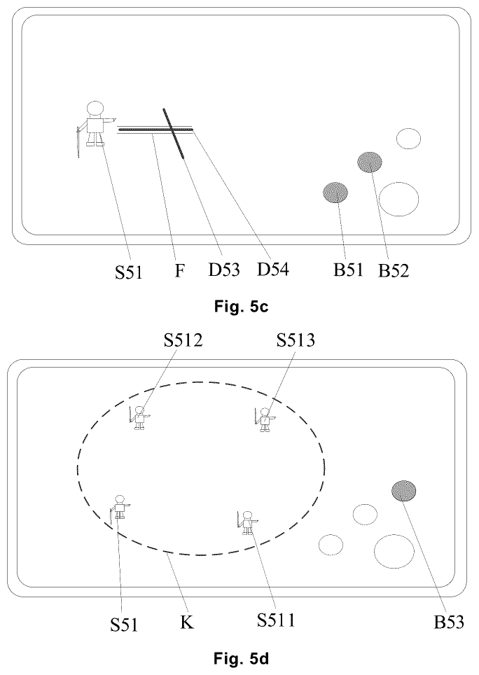

The user uses the target hero to battle in the virtual scene, and possible battle scenarios include at least those shown in FIG. 5a to FIG. 5d below. Referring to an example diagram of one battle scenarios shown in FIG. 5a, and in FIG. 5a, the user controls the target hero S51 to battle in the virtual scene, the user releases the first skill by triggering the skill button B51, and the target hero S51 waves the knife forward, causing damage to the enemy hero S52 within the skill range T51, and leaving a knife mark D51.

Referring to another example diagram of a battle scenario shown in FIG. 5b, and in FIG. 5b, the user releases the second skill by triggering the skill button B52, and the target hero S51 sprints forward to cause damage to the target on the sprint path F and leave a knife mark D52. At this time, the knife mark D52 and the knife mark D51 contact with each other and explode and cause damage to the enemy hero S52.

Referring to an example diagram of still another battle scenario shown in FIG. 5c, and in FIG. 5c, the user releases the second skill by triggering the skill button B52, and releases the first skill by triggering the skill button B51 while the target hero S51 is sprinting forward, and controls the target hero S51 to immediately make a transverse cut in the sprinting direction, so as to cause damage and leave a knife mark D53. At this time, the knife mark D53 and the knife mark D54 left on the sprinting path F contact with each other and explode.

Referring to an example diagram of still another battle scenario shown in FIG. 5d, and in FIG. 5d, the user triggers the skill button B53 to release the third skill, a field K is generated in the virtual scene, and the target hero S51 in the field summons three clones (clone S511, clone S512, and clone S513) to assist in the battle, and the three clones mimic the movements and skills of the target hero S51.

The user controls the target hero to release the target skill (the first skill or the second skill) in the virtual scene and leave a knife mark, and when the knife mark is in contact with other knife marks existing in the virtual scene, explosion occurs. Therefore, when the user releases the target skill, the release position of the target skill can be controlled, and thus the position of the knife mark left after the target skill is released is adjusted. Therefore, the knife mark is made to be in contact with other knife marks existing in the virtual scene to maximize the damage, and the optimal skill release effect is achieved.

In addition, the timing of releasing the target skill to make the knife mark come into contact with existing knife mark in the virtual scene can be controlled by the user, and the user can realize a variety of gameplay based on this mechanism. For example, the knife mark existing in the virtual scene can be used as a trap, and when the enemy hero enters the range of the knife mark, the target skill can be released such that the knife mark of the target skill contacts the knife mark under the foot of the enemy hero to cause explosion damage. Otherwise, the existing knife marks in the virtual scene can be utilized to limit the movement of the enemy hero, so that the enemy hero cannot easily approach the knife marks.

Therefore, the preset skill effects can be triggered by controlling the release position of the skill, and then adjusting the position of the skill trace left after the skill is released, so that the skill trace left by the skill satisfies the preset position condition. Thus, the trace released by the skill can be flexibly determined according to the progress of the game or prediction, so as to control the effective range of the skill, the damage intensity of the skill and other skill effects, and increase the flexibility of control during the skill release process.

In addition, the second skill trace in the to-be-triggered state can also be used as a trap, and the maximization of the skill benefit is achieved at a proper timing when the first skill trace and the second skill trace left by releasing the target skill satisfy the preset position condition. Therefore, the combined skill is released by the skill traces left when the target skills was released, the skill interaction can be realized by utilizing the change of the target skills to the virtual scene in the game, and the interactivity between the skill release and the virtual scene and the interestingness are increased.

It will be understood by those of skill in the art that in the above method of the present embodiment, the order of writing the steps does not imply a strict order of execution and does not impose any limitations on the embodiment, as the order of execution of the steps should be determined by their function and possibly inherent logic.

Based on the same inventive concept, an interaction control device corresponding to the interaction control method is also provided by the embodiments of the present disclosure, and since the principle of solving the problem by the device in the embodiments of the present disclosure is similar to the interaction control method described above in the embodiments of the present disclosure, the embodiment of the device can refer to the embodiment of the method, and the repeated parts are not described again.

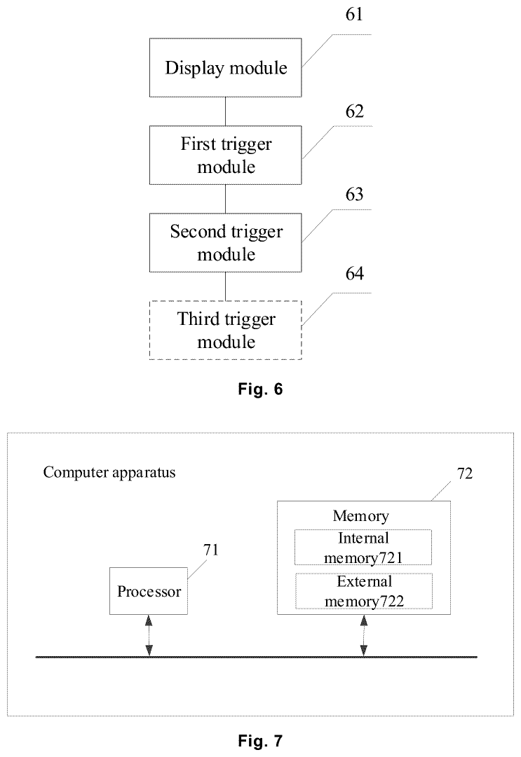

Referring to FIG. 6, a schematic diagram of an interaction control apparatus provided in an embodiment of the present disclosure is shown, where the apparatus includes: a display module 61, a first trigger module 62 and a second trigger module 63; wherein
the display module 61 is configured to display a virtual scene and at least one first skill button in a display interface of a terminal equipment; the virtual scene comprises a first virtual character;
a first trigger module 62, configured to, in response to a triggering operation on a target skill button of the at least one first skill button, control the first virtual character to release a target skill corresponding to the target skill button and determining a first skill trace corresponding to the target skill;
a second trigger module 63, configured to, in response to positions of the first skill trace and a second skill trace in a to-be-triggered state in the virtual scene satisfying a preset position condition, trigger a preset skill effect based on the first skill trace and the second skill trace; wherein the second skill trace is determined at historical time by triggering one of the at least one first skill button.

In a possible embodiment, the second trigger module 63 is further configured to:
after the preset skill effect is triggered based on the first skill trace and the second skill trace, control the first skill trace and the second skill trace to disappear.

In a possible embodiment, the first trigger module 62 is further configured to:
in response to the second skill trace not existing currently or the positions of the first skill trace and the second skill trace not satisfying the preset position condition, control the first skill trace to enter a to-be-triggered state.

In a possible embodiment, the first trigger module 62 is further configured to:
after the first skill trace enters the to-be-triggered state, if the first skill trace is not triggered within a preset time period, control the first skill trace to disappear.

In a possible embodiment, the second trigger module 63, when triggering a preset skill effect based on the first skill trace and the second skill trace, is further configured to:
determine an effective area of the preset skill effect based on the first skill trace and the second skill trace; and
trigger the preset skill effect in the effective area.

In a possible embodiment, the display module 61 displays an information indication control in the display interface; the information indication control is configured to display a residual amount of virtual resource; the virtual resource is used for releasing a skill corresponding to the at least one first skill button;
the first trigger module 62, after in response to a triggering operation on a target skill button of the at least one first skill button, controlling the first virtual character to release a target skill corresponding to the target skill button, is further configured to:
determine whether the current residual amount satisfies a release condition of the skill corresponding to the at least one first skill button;
in response to the current residual amount not satisfying the release condition of the skill, control the at least one first skill button to enter an untriggerable state; and in response to the current remaining amount satisfying the release condition of the skill, control the at least one first skill button to remain in a triggerable state.

In a possible embodiment manner, the display module 61 further displays a second skill button in the display interface, the apparatus further including a third trigger module 64 configured to:
in response to a triggering operation on the second skill button, determine a target area in the virtual scene based on a current position of the first virtual character, and generating at least one third virtual character associated with the first virtual character in the target area;
the third trigger module 64, when in response to a triggering operation on a target skill button of the at least one first skill button, control the first virtual character to release a target skill corresponding to the target skill button and determine a first skill trace corresponding to the target skill, is further configured to:
in a case where the first virtual character is located in the target area, in response to the triggering operation on the target skill button of the at least one first skill button, control the first virtual character and the third virtual character to release the target skill corresponding to the target skill button, and determine the first skill traces of the target skill released by the first virtual character and the third virtual character respectively.

In a possible embodiment, the third trigger module 64 is further configured to:
in response to the first skill traces corresponding to the first virtual character and the third virtual character respectively satisfying the preset position condition, trigger the preset skill effect based on the first skill traces corresponding to the first virtual character and the third virtual character respectively.

In a possible embodiment, the third trigger module 64 is further configured to:
preserve skill traces in the target area; the preserved skill traces include: the first skill trace and the second skill trace; and
in response to a disappearance of the target area, trigger the preset skill effect based on the skill traces preserved in the target area.

In a possible embodiment, the third trigger module 64 is further configured to:
in response to the first virtual character moving within the target area, control the third virtual character to move within the target area based on a manner in which the first virtual character moves within the target area.

In one possible embodiment, the third trigger module 64, when in response to a triggering operation on a target skill button of the at least one first skill button, control the first virtual character to release a target skill corresponding to the target skill button, is further configured to:
in response to a triggering operation on the target skill button of the at least one first skill button and when the first virtual character is located within the target area, controlling the first virtual character to release the target skill corresponding to the target skill button without consuming virtual resource; the virtual resource is used for releasing a skill corresponding to the at least one first skill button; and
when the first virtual character is located outside the target area, controlling the first virtual character to release the target skill corresponding to the target skill button by consuming the virtual resource.

An embodiment of the present disclosure further provides a computer apparatus, as shown in FIG. 7, which is a schematic structural diagram of the computer apparatus provided by the embodiment of the present disclosure, and includes:
a processor 71 and a memory 72; the memory 72 stores machine-readable instructions executable by the processor 71, the processor 71 being configured to execute the machine-readable instructions stored in the memory 72, the machine-readable instructions, when executed by the processor 71, cause the processor 71 to perform the following steps:
display a virtual scene and at least one first skill button in a display interface of a terminal equipment; the virtual scene comprises a first virtual character;
in response to a triggering operation on a target skill button of the at least one first skill button, control the first virtual character to release a target skill corresponding to the target skill button and determine a first skill trace corresponding to the target skill; and
in response to positions of the first skill trace and a second skill trace in a to-be-triggered state in the virtual scene satisfying a preset position condition, trigger a preset skill effect based on the first skill trace and the second skill trace; wherein the second skill trace is determined at historical time by triggering one of the at least one first skill button.

The memory 72 includes an internal memory 721 and an external memory 722; the internal memory 721 is also referred to as a memory, and temporarily stores operation data in the processor 71 and data exchanged with an external memory 722 such as a hard disk, and the processor 71 exchanges data with the external memory 722 through the internal memory 721.

For the specific execution process of the instruction, reference can be made to the steps of the interaction control method described in the embodiments of the present disclosure, and details are not described here again.

The embodiments of the present disclosure further provide a computer-readable storage medium, on which a computer program is stored, and when the computer program is executed by a processor, the computer program performs the steps of the interaction control method in the foregoing method embodiments. The storage medium can be a volatile or non-volatile computer-readable storage medium.

An embodiment of the present disclosure further provides a computer program product, where the computer program product carries a program code, and instructions included in the program code can be used to execute the steps of the interaction control method in the foregoing method embodiment, which can be specifically referred to in the foregoing method embodiment and are not described herein again.

The computer program product can be implemented by hardware, software or a combination thereof. In an alternative embodiment, the computer program product is embodied in a computer storage medium, and in another alternative embodiment, the computer program product is embodied in a Software product, such as a Software Development Kit (SDK) or the like.

It can be clearly understood by those skilled in the art that, for convenience and simplicity of description, the specific working process of the system and the apparatus described above can refer to the corresponding process in the foregoing method embodiment, and details are not described herein again. In the several embodiments provided by the present disclosure, it should be understood that the disclosed system, apparatus and method can be implemented in other ways. The above-described apparatus embodiments are merely illustrative, and for example, the division of the units is only in terms of logical function and can be implemented in other ways, and for example, multiple units or components can be combined or integrated into another system, or some features can be omitted, or not implemented. In addition, the shown or discussed coupling or direct coupling or communication connection between each other can be through some communication interfaces, indirect coupling or communication connection between devices or units, and can be in an electrical, mechanical or other form.

The units described as separate parts may or may not be physically separate, and parts displayed as units may or may not be physical units, may be located in one position, or may be distributed on multiple network units. Some or all of the units can be selected according to actual needs to achieve the purpose of the solution of the embodiment.

In addition, functional units in the embodiments of the present disclosure may be integrated into one processing unit, or each unit may exist alone physically, or two or more units are integrated into one unit.

The functions, if implemented in software functional units and sold or used as a stand-alone product, may be stored in a non-transitory computer-readable storage medium executable by a processor. Based on such understanding, the technical solutions of the present disclosure, which are essential or part of the technical solutions contributing to the prior art, may be embodied in the form of a software product, which is stored in a storage medium and includes several instructions for causing a computer apparatus (which can be a personal computer, a server, or a network device) to execute all or part of the steps of the methods described in the embodiments of the present disclosure. The aforementioned storage medium includes: a U-disk, a removable hard disk, a Read-Only Memory (ROM), a Random Access Memory (RAM), a magnetic disk, an optical disk, or other various media capable of storing program codes.

Finally, it should be noted that: the above-mentioned embodiments are merely specific embodiments of the present disclosure, which are used to illustrate the technical solutions of the present disclosure, but not to limit the technical solutions, and the scope of the present disclosure is not limited thereto. Although the present disclosure is described in detail with reference to the foregoing embodiments, those of ordinary skill in the art should understand that: those skilled in the art can still make modifications or changes to the embodiments described in the foregoing embodiments, or make equivalent substitutions for some of the technical features, within the technical scope of the disclosure; such modifications, changes and substitutions do not depart from the spirit and scope of the embodiments disclosed herein, and they should be construed as being included therein. Therefore, the protection scope of the present disclosure shall be subject to the protection scope of the claims.

What is claimed is:

1. An interaction control method, comprising:
displaying a virtual scene and at least one first skill button in a display interface of a terminal equipment; the virtual scene comprises a first virtual character;
in response to a triggering operation on a target skill button of the at least one first skill button, controlling the first virtual character to release a target skill corresponding to the target skill button and determining a first skill trace corresponding to the target skill; and
in response to positions of the first skill trace and a second skill trace in a to-be-triggered state in the virtual scene satisfying a preset position condition, triggering a preset skill effect based on the first skill trace and the second skill trace; wherein the second skill trace is determined at historical time by triggering one of the at least one first skill button.

2. The method of claim 1, wherein the method further comprises:
after the preset skill effect is triggered based on the first skill trace and the second skill trace, controlling the first skill trace and the second skill trace to disappear.

3. The method of claim 1, wherein the method further comprises:
in response to the second skill trace not existing currently or the positions of the first skill trace and the second skill trace not satisfying the preset position condition, controlling the first skill trace to enter a to-be-triggered state.

4. The method of claim 3, wherein the method further comprises:
after the first skill trace enters the to-be-triggered state, if the first skill trace is not triggered within a preset time period, controlling the first skill trace to disappear.

5. The method of claim 1, wherein the triggering a preset skill effect based on the first skill trace and the second skill trace comprises:
determining an effective area of the preset skill effect based on the first skill trace and the second skill trace; and
triggering the preset skill effect in the effective area.

6. The method of claim 1, wherein an information indication control is displayed in the display interface; the information indication control is configured to display a residual amount of virtual resource; the virtual resource is used for releasing a skill corresponding to the at least one first skill button;
the after in response to a triggering operation on a target skill button of the at least one first skill button, controlling the first virtual character to release a target skill corresponding to the target skill button, the method further comprises:
determining whether the current residual amount satisfies a release condition of the skill corresponding to the at least one first skill button;
in response to the current residual amount not satisfying the release condition of the skill, controlling the at least one first skill button to enter an untriggerable state; and
in response to the current remaining amount satisfying the release condition of the skill, controlling the at least one first skill button to remain in a triggerable state.

7. The method of claim 1, wherein the preset position condition comprises at least one of:
the first skill trace and the second skill trace intersect, are parallel or are tangent, or a distance between the first skill trace and the second skill trace is less than a preset distance threshold value.

8. The method of claim 1, wherein the display interface further displays: a second skill button; the method further comprises:
in response to a triggering operation on the second skill button, determining a target area in the virtual scene based on a current position of the first virtual character, and generating at least one third virtual character associated with the first virtual character in the target area;
the in response to a triggering operation on a target skill button of the at least one first skill button, controlling the first virtual character to release a target skill corresponding to the target skill button and determining a first skill trace corresponding to the target skill comprises:
in a case where the first virtual character is located in the target area, in response to the triggering operation on the target skill button of the at least one first skill button, controlling the first virtual character and the third virtual character to release the target skill corresponding to the target skill button, and determining the first skill traces of the target skill released by the first virtual character and the third virtual character respectively.

9. The method of claim 8, wherein the method further comprises:
in response to the first skill traces corresponding to the first virtual character and the third virtual character respectively satisfying the preset position condition, triggering the preset skill effect based on the first skill traces corresponding to the first virtual character and the third virtual character respectively.

10. The method of claim 8, wherein the method further comprises:
preserving skill traces in the target area; the preserved skill traces comprise: the first skill trace and the second skill trace; and
in response to a disappearance of the target area, triggering the preset skill effect based on the skill traces preserved in the target area.

11. The method of claim 8, wherein the method further comprises:
in response to the first virtual character moving within the target area, controlling the third virtual character to move within the target area based on a manner in which the first virtual character moves within the target area.

12. The method of claim 8, wherein the method further comprises:
in response to a duration of existence of the target area reaching a preset duration, controlling the target area to disappear; and/or
in response to the first virtual character moving from within the target area to outside the target area, controlling the target area to disappear.

13. The method of claim 8, wherein the in response to a triggering operation on a target skill button of the at least one first skill button, controlling the first virtual character to release a target skill corresponding to the target skill button comprises:
in response to a triggering operation on the target skill button of the at least one first skill button and when the first virtual character is located within the target area, controlling the first virtual character to release the target skill corresponding to the target skill button without consuming virtual resource; the virtual resource is used for releasing a skill corresponding to the at least one first skill button; and
when the first virtual character is located outside the target area, controlling the first virtual character to release the target skill corresponding to the target skill button by consuming the virtual resource.

14. A computer apparatus, comprising: a processor, a memory storing machine-readable instructions executable by the processor, the processor is configured to execute the machine-readable instructions stored in the memory, the machine-readable instructions, when executed by the processor, cause the processor to:
display a virtual scene and at least one first skill button in a display interface of a terminal equipment; the virtual scene comprises a first virtual character;
in response to a triggering operation on a target skill button of the at least one first skill button, control the first virtual character to release a target skill corresponding to the target skill button and determine a first skill trace corresponding to the target skill; and
in response to positions of the first skill trace and a second skill trace in a to-be-triggered state in the virtual scene satisfying a preset position condition, trigger a preset skill effect based on the first skill trace and the second skill trace; wherein the second skill trace is determined at historical time by triggering one of the at least one first skill button.

15. The computer apparatus of claim 14, wherein the machine-readable instructions, when executed by the processor, further cause the processor to:
in response to the second skill trace not existing currently or the positions of the first skill trace and the second skill trace not satisfying the preset position condition, control the first skill trace to enter a to-be-triggered state.

16. The computer apparatus of claim 14, wherein the machine-readable instructions, when executed by the processor, further cause the processor to:
display a second skill button in the display interface; and
in response to a triggering operation on the second skill button, determine a target area in the virtual scene based on a current position of the first virtual character, and generate at least one third virtual character associated with the first virtual character in the target area;
in a case where the first virtual character is located in the target area, in response to the triggering operation on the target skill button of the at least one first skill button, control the first virtual character and the third virtual character to release the target skill corresponding to the target skill button, and determine the first skill traces of the target skill released by the first virtual character and the third virtual character respectively.

17. A non-transitory computer-readable storage medium, wherein a computer program is stored on the computer-readable storage medium, the computer program, when executed by a computer apparatus, cause the computer apparatus to:
display a virtual scene and at least one first skill button in a display interface of a terminal equipment; the virtual scene comprises a first virtual character;
in response to a triggering operation on a target skill button of the at least one first skill button, control the first virtual character to release a target skill corresponding to the target skill button and determine a first skill trace corresponding to the target skill; and
in response to positions of the first skill trace and a second skill trace in a to-be-triggered state in the virtual scene satisfying a preset position condition, trigger a preset skill effect based on the first skill trace and the second skill trace; wherein the second skill trace is determined at historical time by triggering one of the at least one first skill button.

18. The storage medium of claim 17, wherein the computer program, when executed by a computer apparatus, further cause the computer apparatus to:
in response to the second skill trace not existing currently or the positions of the first skill trace and the second skill trace not satisfying the preset position condition, control the first skill trace to enter a to-be-triggered state.

19. The storage medium of claim 17, wherein the computer program, when executed by a computer apparatus, further cause the computer apparatus to:
display a second skill button in the display interface; and
in response to a triggering operation on the second skill button, determine a target area in the virtual scene based on a current position of the first virtual character, and generate at least one third virtual character associated with the first virtual character in the target area;
in a case where the first virtual character is located in the target area, in response to the triggering operation on the target skill button of the at least one first skill button, control the first virtual character and the third virtual character to release the target skill corresponding to the target skill button, and determine the first skill traces of the target skill released by the first virtual character and the third virtual character respectively.
